(19) United States
(12) Patent Application Publication
(10) Pub. No.: US 2014/0331455 A1
(43) Pub. Date: Nov. 13, 2014

(54) METHOD AND MACHINERY FOR MAKING NANOFIBRES

(71) Applicant: HERIOT WATT UNIVERSITY, Galashiels (GB)

(72) Inventors: George Stylios, Galashiels (GB); Liang Luo, Galashiels (GB)

(21) Appl. No.: 14/241,982

(22) PCT Filed: Aug. 29, 2012
(86) PCT No.: PCT/GB2012/000684

§ 371 Date: Jul. 2, 2014

(30) Foreign Application Priority Data
Aug. 29, 2011 (GB) 1114856.6
Apr. 27, 2012 (GB) 1207353.2

(51) Int. Cl. D01G 15/84; D01D 5/00

(52) U.S. Cl. CPC D01G 15/84; D01D 5/0092; B29L 2031/731
USPC 19/114; 264/465; 425/8

(57) ABSTRACT

Electrospinning from a melt or solution by means of an electric field between a fibre source such as a spinneret or a bubble surface and a moving collector comprising a wire card of which the wires are electrically connected. The spinneret or melt or solution may be held at high potential and the wires earthed. The method produces an aligned nanofibre web that can be made into strands, yarns, cable or rope or non-woven fabrics such as stitch bonded and stitch knitted fabric.

This invention relates to nanofibres.

Spinning nanofibres from polymer solution or melt is discussed inter alia in WO2011/015161 and WO2009/042138.

The easiest and most widely practised method, as disclosed in WO2011/015161, of spinning nanofibres involves a metering pump that regulates the solution or melt feed rate, a spinneret though which the solution or melt is directed, and a collector, with a source of high voltage, about 15,000 volts, applied to the spinneret or directly into the solution or melt. In another arrangement, the spinneret is earthed and the collector is charged. In another arrangement, disclosed in WO2009/042138, the spinneret is replaced by a surface of bubbles on the solution or melt, fibres being pulled by the electrostatic field directly from the surfaces of the bubbles. Nanofibres are formed at the spinneret, or the bubble surface, and fly, as a result of the electrostatic field, towards an earthed collector. So far, this has been found to be less efficient than if the collector is earthed and the spinneret charged, and there are also safety considerations in commercial operations.

The collector has a moving surface on to which the nanofibres are collected and from which they are subsequently removed. The moving surface is usually the surface of a rotary cylinder of some sort.

The nanofibres are collected on the surface in the form of a web, much like a conventional non-woven matt. Fibres so collected, and the web itself, have various applications, principally as filters.

However, it would be desirable to be able to form coherent strand or yarn materials, and to form nanofibre webs from which such strand or yarn materials may be formed, which could better exploit the inherent tensile strength of the nanofibres. An attempt has been made at this as disclosed in WO2008/062264, which describes an electrospinning process in which the collector comprises a plurality of conductive strips that are separated one from another by insulation or an air gap, which are inclined to the direction of movement of the collector, e.g. set at 90° to that direction. The strips are electrically connected at the edges of the collector. Fibres landing on the collector tend, it is said, to span a pair or a number of adjacent strips by folding between them. The fibres are drawn off by the conventional (for electrospinning) web collector rollers, and fed into a web twister before passing to drawing rollers. It is said that the fibres will generally not simply fold back on themselves to form a neat 180° bend, but that each fold may be chaotic and include a number of random loops and other random patterns. The fibres are said to show a high degree of alignment, much more so than with prior art industrial processes.

The ‘yarns’ produced according to WO2008/062264, however, are clearly not like conventional textile yarns made from aligned, separate fibres twisted together, rather a web of fibres somewhat better aligned than prior art electrospinning processes had managed to produce, that is simply twisted into a twisted web comprising randomly folded fibres.

The present invention provides methods and apparatus capable of forming coherent strand and yarn materials, and to form nanofibre webs from which such strand or yarn materials may be formed, which could better exploit the inherent tensile strength of the nanofibres than conventional electrospinning technologies.

The invention comprises a method for making nanofibres comprising electrospinning from a melt or solution by means of an electric field between a fibre source and a moving collector comprising a wire card of which the wires are electrically connected.

A wire card is a device used in conventional fibre preparation where the raw material is a bale of fibres as may be collected by shearing sheep or ginning cotton. One form of card is a stiff backing sheet with wire staples inserted from the back surface with the pins sticking out from the front face like a more or less dense hairbrush. Other ‘wire’ cards are made from serrated wire wound on a backing. A carding machine has a cylinder of wire card ‘clothing’ on to which the fibres are placed, and a series of rollers known as workers and strippers that lift the fibres off the cylinder straightening them out and replacing them until eventually they are substantially completely aligned ready for spinning into yarns.

The card wires are not electrically connected, simply being stuck through the backing or, in the case of serrated wire cards, wound individually on the backing. Such carding materials will not collect electrospun fibres any better than any other form of collector. When the wires are, however, electrically connected, it is found that the fibres are collected in very orderly fashion. Fibres thus collected, in fact, require little or no further alignment. If an industrial carding machine is used, the number of workers and strippers may be substantially reduced, and they may not even be required at all.

The fibre source may comprise a spinneret or multiple spinnerets, or a bubble surface.

Usually, the fibre source, the spinneret, or the bubble surface container, or the solution or melt, will be maintained at a high potential, usually 15,000 volts or more, while the card wires are earthed, but the source may be earthed and the card wires held at a high potential.

The card can be in the form of a drum, and in particular a woollen or worsted card drum, but a belt or even a flat card may be used.

The card surface may be placed at a distance from the spinneret and have a surface speed such that nanofibres are collected on the wires of the card and oriented in a parallel arrangement on the card surface along the direction in which it travels. The rate may be such that the fibres have time fully to dry on the card surface before they are collected. With conventional electrospinning collecting arrangements, the fibres are still wet, either because they still retain solvent, or are still melted, and they bond together where the are in contact, which is why they form a non-woven web rather than individual fibres.

The length of fibres so made is affected, and may be controlled, by the applied voltage and/or the viscosity of the solution or melt.

Collection may be effected in any of the usual ways for a woollen or worsted card, as by using a Swift or doffer roller or a fly card. As the nanofibres are well aligned ab initio on the card wires, at least some of the usual stripper and worker rollers may not be needed, nor a fancy roller. Essentially, a Swift roller with a fly comb will suffice for many applications.

The points or pins of conventional card wires are not normally electrically connected. The wires are usually ‘staples’ fixed in a textile backing. To ground the wires, the back of the card may be soldered to connect all the wires electrically, and it is only then necessary to ground the solder. Wires may be made of any electrically conductive material, including conductive plastic, which would then be connected by conductive plastic ‘solder’. Of course, special manufacturing techniques may be developed for manufacturing card clothing in which all the points are electrically connected without needing to be rendered'so as by soldering.

Better results may be obtained by making the points of the wires as fine as possible.

The invention comprises card wires of which the points or pins are electrically connected, whether they be specially constructed so as to be inherently connected, or rendered electrically connected as by soldering the back of the card wire.

A card may be made with a conductive backing material, such as a warp knit fabric of metal filaments bonded to a non-conductive face material, the card wires being stapled through the material to project from the non-conductive face material.

And the invention also comprises a card or like wire collector of which the points or pins of the wires are electrically connected so as to be adapted to be held at an electric potential relative to a spinneret in an electrospinning arrangement, as well as machinery for making nanofibres comprising such collectors.

Once the nanofibres are collected, in sliver, roving or other format, they can be treated as other fibres and converted using conventional spinning methods such as ring spinning, mule spinning, rotor spinning into twisted strands, which may be plied as usual into yarns, ropes, or cables, or may be collected as a car web and cross-folded to make for example stitch bonded, stitch knitted or otherwise bonded non-woven materials, and the invention comprises sliver, roving, twisted strands, plied yams, ropes cables and stitch bonded or otherwise bonded card web of nanofibres collected made by a method as disclosed herein.

Methods for making nanofibres according to the invention and nanofibre products made therefrom, as well as card wires, cards and other fibre collectors and nanofibre making machinery incorporating the same will now be described with reference to the accompanying drawings, in which:

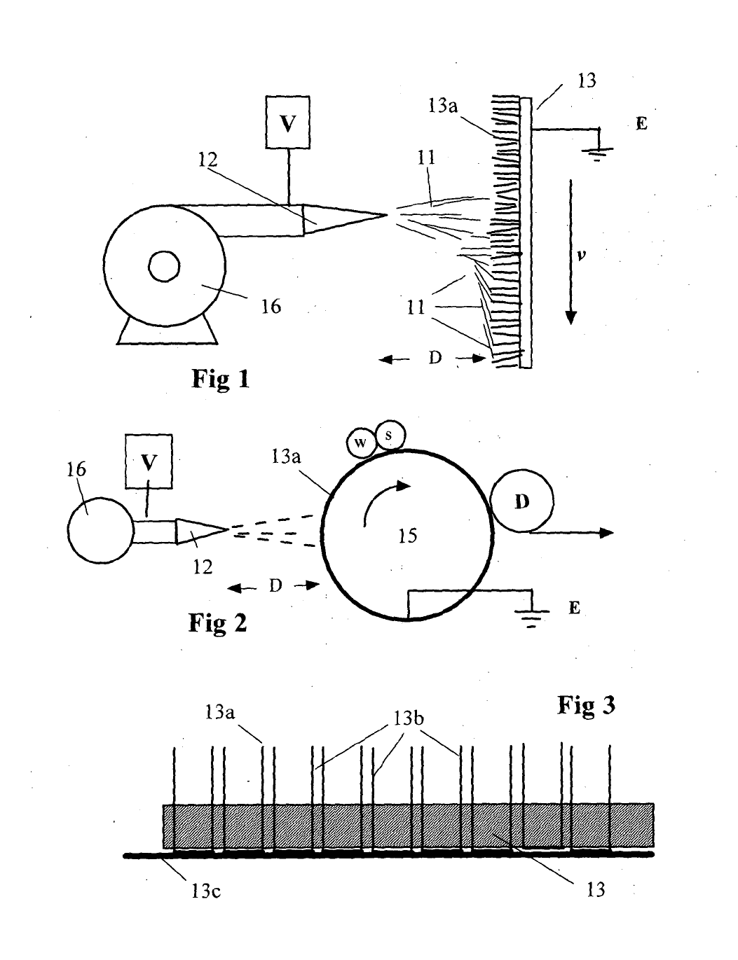

FIG. 1 is a schematic view showing the method;

FIG. 2 is a schematic view showing a basic woollen or worsted card collector;

FIG. 3 is a schematic cross-section of a one embodiment of card wire;

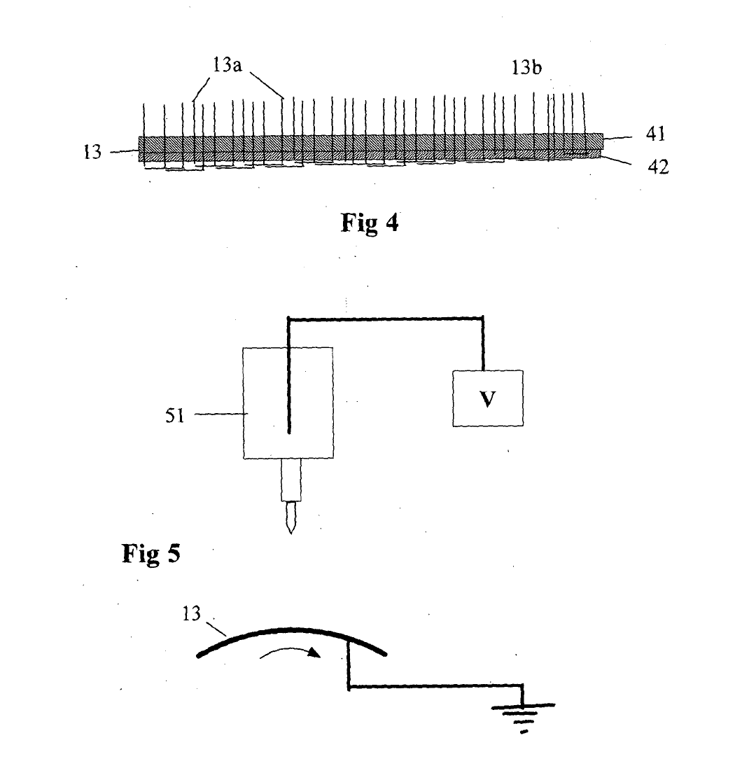

FIG. 4 is a schematic of another embodiment of card wire;

FIG. 5 is a schematic view of another method; and

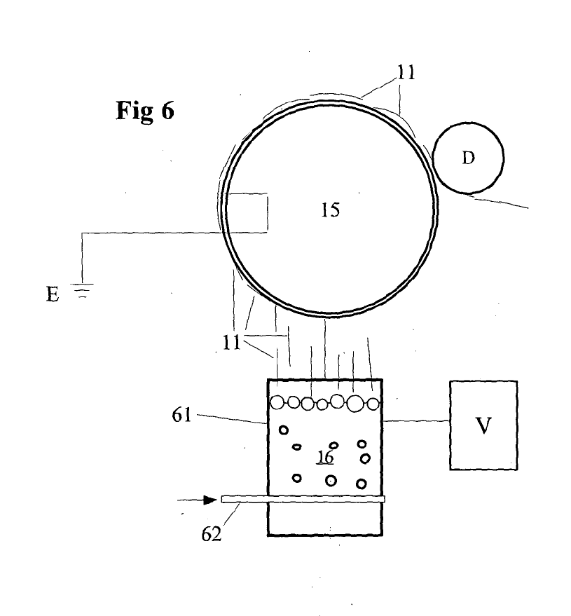

FIG. 6 is a schematic view of a bubble surface method.

The drawings illustrate a method for making nanofibres 11 comprising spinning them from a spinneret 12, FIG. 1, charged to high voltage from a source V. The spinneret 15 is fed from a metering pump 16 towards a moving collector 13 comprising a wire card of which the wires 14 are earthed. In FIG. 5, the source V injects the high voltage directly into the melt or solution 51. In FIG. 6, an open-topped container 61 for the melt or solution 16 is held at a high potential V, and air or another gas injected via a tube 62 to form bubbles 63 from which fibres 11 are generated by the electrostatic field.

The card 13 can be in the form of a drum 15, as shown in FIG. 2, and in particular a woollen or worsted card drum, but a belt or even a flat card may be used instead.

The card surface 13a is placed at a distance D from the spinneret 12 and has a surface speed v such that nanofibres 11 are collected on the points of the wires 13b of the card 13 and oriented in a parallel arrangement on the card surface 13a along the direction in which it travels. The rate is such that the fibres 11 have time fully to dry on the card surface before they are collected, and the orientation is such that they do not generally fuse one with another.

Collection from the drum 15 may be effected in any of the usual ways for a woollen or worsted card, as by using a Swift or doffer roller or a fly card. As the nanofibres are well aligned ab initio on the card wires, at least some of the usual stripper S and worker W rollers may not be needed, nor a fancy roller. Essentially, a Swift roller with a fly comb will suffice for many applications.

The points or pins of card wires are not normally electrically connected. The wires are usually ‘staples’ 13b-fixed in a backing; as shown in FIG. 3. To ground the wires, the back of the card 13 is given a layer of solder 13c to connect all the wires 13b electrically, and it is only then necessary to ground the solder 13c. Wires 13b may be made of any electrically conductive material, including conductive plastic.

Of course, a card may, for the present purpose, be specially made so that all the wires are electrically connected without the need for soldering. Such a card 13 is illustrated in FIG. 4 and comprises a layer of non-conductive textile material 41, which can be any material from which card wires are normally made, and a conductive backing material 42, such as a warp knit fabric of metal filaments. The staples 13b are in electrical contact with the backing 42, and therefore with each other.

Better results may be obtained by making the points of the wires 13b as fine as possible.

Instead of the arrangements illustrated, in which the spinneret or melt or solution is held at a high potential and the card wires are earthed, the card wires may he held at a high potential and the spinneret or melt or solution earthed. This arrangement has a greater burden of safety requirements, and does not appear to be so productive as the arrangements illustrated.

Once the nanofibres are collected, in sliver, roving or other format, they can be treated as other fibres and converted using conventional spinning methods such as ring spinning, mule spinning, rotor spinning into twisted strands, which may be plied as usual into yarns, ropes, or cables, or may be collected as a car web and cross-folded to make for example stitch bonded, stitch knitted or otherwise bonded non-woven materials, and the invention comprises sliver, roving, twisted strands, plied yarns, ropes cables and stitch bonded or otherwise bonded card web of nanofibres collected made by a method as disclosed herein.

Nanofibres have high surface-to-volume ratio and are strong, highly absorbent, good carriers of other substances, and are easy to blend. Nanofibre card webs made according to the invention can be made into sliver, or roving, from which twisted strands may be made on spinning frames and from which yarns, cables, ropes and other textile structures may be made. The ability to make elongate structures such as yarns and ropes more fully exploits the beneficial properties of the nanofibres. In addition, the card web may be cross-folded and converted as by stitch bonding or stitch knitting into non-woven fabrics.

Moreover, the nanofibres may be further processed into carbon fibres and hybrid fibres that may incorporate nanotubes along their axes, which have very high specific tensile strength.

1. A method for making nanofibres comprising electrospinning from a melt or solution by means of an electric field between a fibre source and a moving collector comprising a wire card of which the wires are electrically connected.

2. A method according to claim 1, in which the fibre source comprises a spinneret or multiple spinnerets.

3. A method according to claim 1, in which the fibre source comprises a bubble surface.

4. A method according to claim 1, in which the fibre source is held at a high electric potential and the card wires are earthed.

5. A method according to claim 1, in which the card is in the form of a drum, such as a woollen or worsted card drum.

6. A method according to claim 1, in which the card is in the form of a belt.

7. A method according to claim 1, in which a flat card is used.

8. A method according to claim 1, in which the card surface is placed at a distance from the spinneret and has a surface speed such that nanofibres are collected on the wires of the card and oriented in a parallel arrangement on the card surface along the direction in which it travels.

9. A method according to claim 8, in which the rate is such that the fibres have time fully to dry on the card surface before they are collected.

10. A method according to claim 5, in which at least some of the usual stripper and worker rollers are dispensed with.

11. A method according to claim 5, in which collection is effected using essentially a Swift roller with a fly comb.

12. A method according to claim 1, in which a conventional card wire is used, but the wires are electrically connected by soldering.

13. A method according to claim 1, in which the card wire comprises a non-conductive material with a backing of a conductive material such as a warp knitted wire fabric and the wires are in electrical contact with the backing and therefore with each other.

14. A method according to claim 1, in which the points of the wires are as fine as possible.

15. (canceled)

16. Machinery for making nanofibres comprising a fibre collector comprising a card wire of which the wires are electrically connected and adapted to be earthed.

17. Machinery according to claim 16, comprising a metering pump for solution or melt from which nanofibres may be spun, a spinneret fed by the metering pump, and a collector for the nanofibres spaced from the spinneret comprising a card wire, in which the spinneret is held at a high voltage and the wires of the card are earthed.

18-21. (canceled)
